(19) United States
(12) Patent Application Publication
(10) Pub. No.: US 2026/0014872 A1
(43) Pub. Date: Jan. 15, 2026

(54) MODULAR DASHBOARD SYSTEM FOR VEHICLE

(71) Applicant: GM Global Technology Operations LLC, Detroit, MI (US)

(72) Inventors: Younghwa KWON, Incheon (KR); Juyong YUN, Incheon (KR); Kwanseob LEE, Incheon (KR); Haejeong YU, Incheon (KR); Hakjun LEE, Incheon (KR)

(21) Appl. No.: 18/770,820

(22) Filed: Jul. 12, 2024

(51) Int. Cl. B60K 37/00; B60H 1/00; B60K 35/22; B60N 3/00; B60Q 3/10; B60R 16/03

(52) U.S. Cl. CPC B60K 37/00; B60H 1/00564; B60H 1/00664; B60K 35/22; B60Q 3/10; B60R 16/03; B60K 2360/658; B60K 2360/828; B60N 3/00

(57) ABSTRACT

A modular dashboard system including: a dashboard defining a channel; an electrical connector within the channel configured to be connected to a power source; a plurality of modules each configured to be seated within the channel, at least some of the plurality of modules including electrical contacts configured to cooperate with the electrical connector of the channel to power the plurality of modules; and a duct in fluid communication with both the channel and an HVAC system to transfer airflow conditioned by the HVAC system to the channel.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to a modular dashboard system for a vehicle.

Vehicles typically include a dashboard with various displays, instruments, HVAC outlets, etc. Different types of vehicles have different dashboard layouts. The dashboard layout is generally static and customization options are limited.

### SUMMARY

The present disclosure includes, in various features, a modular dashboard system including: a dashboard defining a channel; an electrical connector within the channel configured to be connected to a power source; a plurality of modules each configured to be seated within the channel, at least some of the plurality of modules including electrical contacts configured to cooperate with the electrical connector of the channel to power the plurality of modules; and a duct in fluid communication with both the channel and an HVAC system to transfer airflow conditioned by the HVAC system to the channel.

In further features, the channel is configured to simultaneously receive at least two of the plurality of modules.

In further features, the plurality of modules includes a vent module configured to be seated within the channel and movable between an open position and a closed position to control airflow.

In further features, the plurality of modules includes an instrument panel module with a display configured to display data regarding operation of a vehicle.

In further features, the plurality of modules includes a multi-colored module configured to rotate within the channel to outwardly display surfaces of different colors.

In further features, the plurality of modules includes a multi-surface module configured to rotate within the channel to outwardly display surfaces of different appearances.

In further features, the plurality of modules includes an illuminated module with a light source.

In further features, the plurality of modules includes a display module with a display screen and a base configured to be seated within the channel.

In further features, the plurality of modules includes a personal electronic device module with a base configured to be seated within the channel and a holder configured to support a personal electronic device.

In further features, the personal electronic device module includes the electrical contacts configured to cooperate with the electrical connector of the channel, and includes a current transfer device configured to transfer electrical current to the personal electronic device to charge the personal electronic device.

In further features, the plurality of modules includes an active display module including a display configured to display text.

In further features, the plurality of modules includes a gauge module including a plurality of instrument gauges.

In further features, the plurality of modules includes a flowerpot module defining a receptacle configured to receive a plurality of flowers.

In further features, the plurality of modules includes a fishtank module with a plurality of artificial fish.

In further features, the plurality of modules includes a storage module defining a housing configured to store an item therein.

In further features, the storage module is in fluid communication with the duct to receive airflow from the HVAC system for at least one of heating and cooling a product stored within the housing.

The present disclosure also includes, in various features, a modular dashboard system including: a dashboard defining a channel extending linearly along a width of the dashboard; an electrical connector within the channel configured to be connected to a power source; a plurality of modules each configured to be slid into the channel at one or more openings defined by the channel, at least some of the plurality of modules including electrical contacts configured to cooperate with the electrical connector of the channel to power the plurality of modules; and a duct in fluid communication with both the channel and an HVAC system to transfer airflow conditioned by the HVAC system to the channel, a portion of the duct extending linearly along the channel.

In further features, the plurality of modules includes at least one of a vent module, an instrument panel module, a multi-colored module, a multi-surface module, an illuminated module, a display module, a personal electronic device module, an active display module, a gauge module, a flowerpot module, a fishtank module, and a storage module.

The present disclosure also includes, in various features, a modular dashboard system including: a dashboard defining a channel extending linearly along a width of the dashboard; an electrical connector within the channel configured to be connected to a power source; a plurality of modules each configured to be slid into the channel at one or more openings defined by the channel, at least some of the plurality of modules including electrical contacts configured to cooperate with the electrical connector of the channel to power the plurality of modules; and a duct in fluid communication with both the channel and an HVAC system to transfer airflow conditioned by the HVAC system to the channel, a portion of the duct extending linearly along the channel. The channel is configured to simultaneously receive at least two of the plurality of modules; and the plurality of modules includes a vent module configured to be seated within the channel and movable between an open position and a closed position to control airflow out from within the channel.

In further features, the plurality of modules further includes at least one of an instrument panel module, a multi-colored module, a multi-surface module, an illuminated module, a display module, a personal electronic device module, an active display module, a gauge module, a flowerpot module, a fishtank module, and a storage module.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a perspective view of an exemplary vehicle dashboard in accordance with the present disclosure, the dashboard defining a channel configured to receive various modules of the present disclosure;

FIG. 2 illustrates the channel of FIG. 1, and ducting configured to direct airflow from a vehicle HVAC system to the channel;

FIG. 3A illustrates an instrument panel module in accordance with the present disclosure configured to be connected to the channel;

FIG. 3B illustrates a power system of the present disclosure for powering the instrument panel module and any other suitable module;

FIG. 4A is a perspective view of a multi-colored module in accordance with the present disclosure configured to be seated in the channel;

FIG. 4B is a perspective view of a multi-surface module in accordance with the present disclosure configured to be seated in the channel;

FIG. 4C is a perspective view of an illuminated module in accordance with the present disclosure configured to be seated in the channel;

FIG. 4D is a perspective view of a display module in accordance with the present disclosure configured to be seated in the channel;

FIG. 4E is a first personal electronic device module in accordance with the present disclosure configured to be seated in the channel;

FIG. 4F is a second personal electronic device module in accordance with the present disclosure configured to be seated in the channel;

FIG. 4G is an active display module in accordance with the present disclosure configured to be seated in the channel;

FIG. 4H is a gauge module in accordance with the present disclosure configured to be seated in the channel;

FIG. 4I is a flowerpot module in accordance with the present disclosure configured to be seated in the channel;

FIG. 4J is a fishtank module in accordance with the present disclosure configured to be seated in the channel;

FIG. 5 is a perspective view of the instrument panel of FIG. 1 including an exemplary arrangement of various modules within the channel in accordance with the present disclosure;

FIG. 6A is a cross-sectional view taken along line 6A-6A of FIG. 5;

FIG. 6B is a cross-sectional view taken along line 6B-6B of FIG. 5;

FIG. 6C is a cross-sectional view taken along line 60-6C of FIG. 5;

FIG. 6D is a cross-sectional view taken along line 6D-6D of FIG. 5;

FIG. 6E is a cross-sectional view taken along line 6E-6E of FIG. 5 illustrating an exemplary air vent module in accordance with the present disclosure; and

FIG. 6F is a cross-sectional view similar to FIG. 6E but with the air vent module rotated relative to FIG. 6E.

In the drawings, reference numbers may be reused to identify similar and/or identical elements.

### DETAILED DESCRIPTION

The present disclosure includes a modular dashboard system, which allows for customization of a dashboard, such as a vehicle dashboard. The modular dashboard system of the present disclosure applies to dashboards of any suitable vehicle. The present disclosure is not limited to vehicular applications. Thus, the modular system described herein may be configured for use in any suitable non-vehicular application as well.

The modular dashboard system allows for the customization of the dashboard by an end user, an original equipment manufacturer, supplier, etc. One or more of the different modules described herein may be seated in a channel defined by the dashboard at any suitable position within the channel. Some of the plurality of modules include electrical contacts configured to cooperate with an electrical connector of the channel to power the modules. The modules described herein are merely examples of modules that may be seated in the channel of the dashboard. Any other suitably configured modules may be placed into cooperation with the channel of the dashboard as well. The position and selection of different modules may be customized as desired. The channel is configured to cooperate with any suitable after-market modules, which may result in nearly an endless selection of different modules to choose from.

The system includes a duct in fluid communication with both the channel and an HVAC system to transfer airflow conditioned by the HVAC system to the channel. Ventilation modules seated within the channel are configured block or allow airflow into a passenger cabin of the vehicle, and direct the airflow to a desired location within the passenger cabin. The airflow may also be used to heat and/or cool an item, such as food, stored within a storage module seated in the channel.

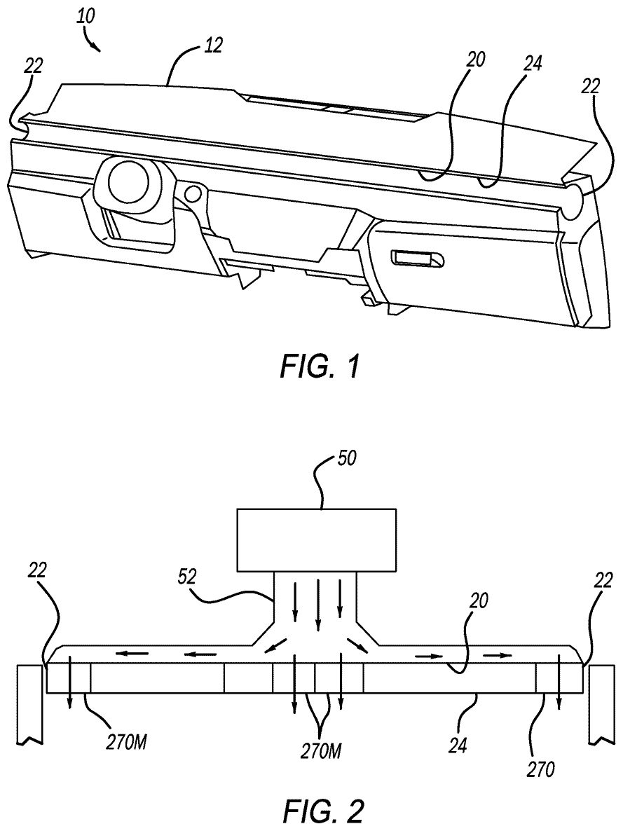

FIG. 1 illustrates an example of a modular dashboard system 10 in accordance with the present disclosure. The system 10 includes a dashboard 12, which in the example illustrated is configured as a vehicle dashboard. The dashboard 12 may be configured for use in any suitable vehicle. The system 10 of the present disclosure may be configured for non-vehicular applications as well.

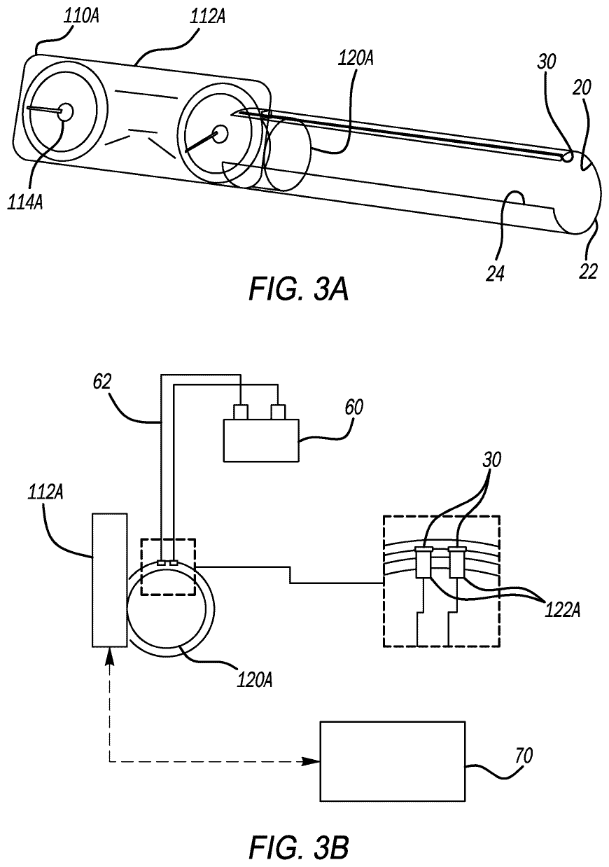

The dashboard 12 defines a channel 20, which extends along a width of the dashboard 12. The channel 20 includes side openings 22 at opposite ends thereof, and defines a front opening 24, which also extends along a width of the dashboard 12. The channel 20 may extend across an entire width of the dashboard 12, or across only portions of the dashboard 12. In addition to, or in place of, the side openings 22, the channel 20 may define one or more intermediate openings. The side openings 22 and the intermediate openings provide entryways for various modules to be inserted into the channel 20 (such as slid into the channel 20 through the side openings 22 or any intermediate openings). The present disclosure includes a plurality of modules, each of which is configured to be seated within the channel 20. Exemplary modules are illustrated in FIGS. 2-6F, and will be described herein.

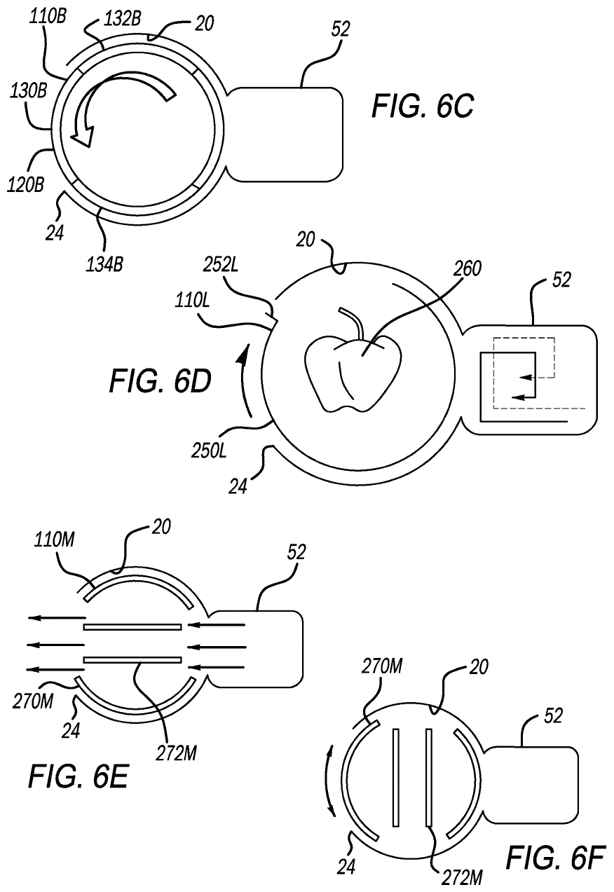

With reference to FIG. 2, the channel 20 is in fluid communication with a heating, ventilation, and air conditioning (HVAC) system 50, such as a vehicle HVAC system. The HVAC system is configured to generate hot and/or cold airflow. A duct 52 connects the HVAC system to the channel 20 to direct the hot and/or cold airflow to the channel 20, and to the modules seated within the channel 20. The airflow may be directed out from within the channel 20 to within a passenger cabin, such as by one or more vent modules 110M (FIGS. 2, 6E, 6F) seated within the channel 20. The airflow may also be used to heat or cool contents of a storage module 110L, such as cool a food item 260 stored within the storage module 110L (see FIG. 6D). The vent modules 110M and the storage module 110L are described in detail herein.

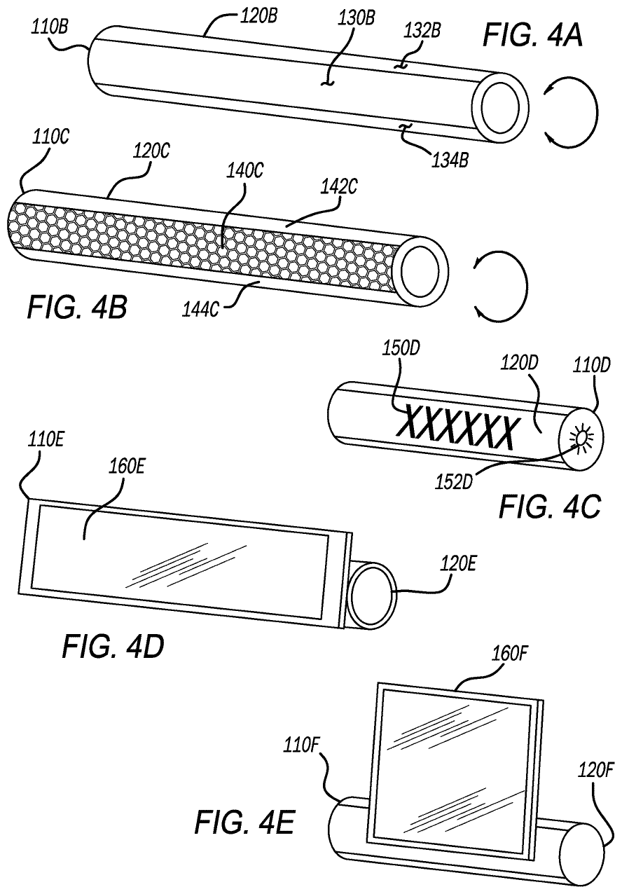

With reference to FIGS. 3A and 3B, the channel 20 includes an electrical connector 30, which extends along an interior of the channel 20. The electrical connector 30 is connected to any suitable power source, such as a battery 60, by way of any suitable electrical connection, such as a wired connection 62. The electrical connector 30 is configured to cooperate with electrical contacts of the modules seated in the channel 20, such as electrical contacts 122A of an instrument panel module 110A, to power the modules. The modules may be controlled in any suitable manner, such as by any suitable controller 70. The controller 70 is configured to communicate with modules seated in the channel 20 by way of any suitable wireless and/or wired connection. For example and with respect to the instrument panel module 110A, the controller 70 is configured to send data to the instrument panel module 110A regarding various vehicle operating conditions, such as velocity, engine speed, fuel level, charge level, etc. for display on the instrument panel module 110A.

The instrument panel module 110A includes a display 112A, which is configured to display status of any suitable vehicle operating parameters, such as vehicle velocity, engine speed, charge level, etc. The display 112A may be configured to display this information in any suitable manner, such as by way of various dials 114A. The instrument panel module 110A includes a base 120A, which is sized and shaped to be received within the channel 20. More specifically, the base 120A is configured to be slid into the channel 20 through either side opening 22 (or a center opening if provided). With the base 120A seated in the channel 20, the display 112A, which is coupled to the base 120A, will be supported by the base 120A outside the channel 20. The electrical contacts 122A of the base 120A will touch the electrical connectors 30 to transfer power from the battery 60 to the electrical contacts 122A to power the instrument panel module 110A.

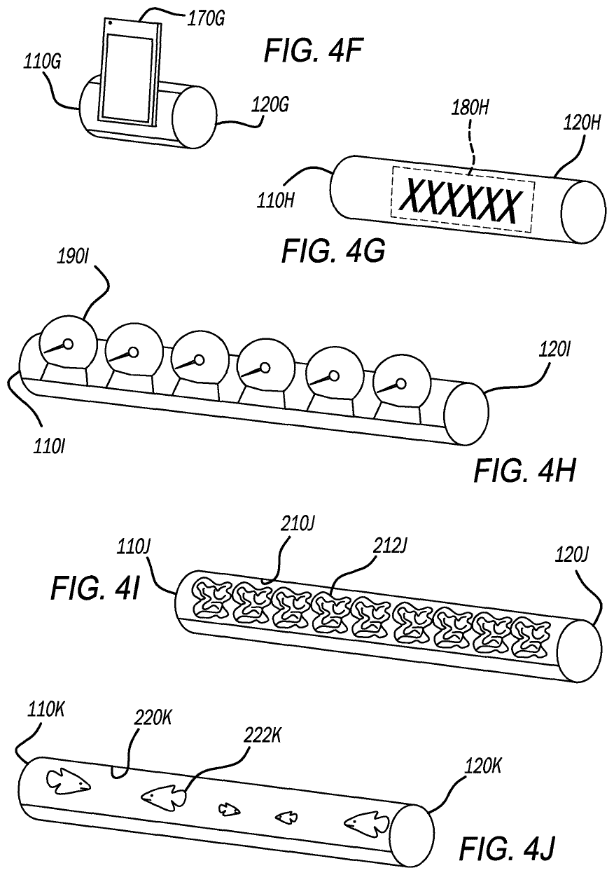

FIG. 4A illustrates a multi-colored module 110B configured to be inserted into the channel 20 in accordance with the present disclosure. The multi-colored module 110B includes a body 120B, which may be cylindrical as illustrated or configured with any other suitable shape. The body 120B includes a plurality of different colored surfaces, such as a first colored surface 130B, a second colored surface 132B, and a third colored surface 134B. Any suitable number of colored surfaces may be included, such as greater or less than three surfaces. The different colors may be painted on the body 120B, or the body 120B may be made of various different panels or portions of different colors that are connected together. The multi-colored module 110B may be unilluminated or illuminated. The body 120B is rotatable within the channel 20 to outwardly display any one of the colored surfaces, such as the first colored surface 130B, the second colored surface 132B, or the third colored surface 134B.

FIG. 4B illustrates a multi-surface module 110C configured to be inserted into the channel 20 in accordance with the present disclosure. The multi-surface module 110C includes various surfaces of various different properties. For example, the multi-surface module 110C includes a body 120C with a first surface 140C, a second surface 142C, and a third surface 144C. The different surfaces 140C, 142C, and 144C may be made of different materials, such as aluminum, carbon, wood, etc. The body 120C may be round or have any other suitable shape to permit rotation of the body 120C within the channel 20 to outwardly display through the front opening 24 of the channel 20 a different material. For example, rotation of the multi-surface module 110C to a first position will expose the first surface 140C, which may be an aluminum surface. Rotation of the multi-surface module 110C to a second position will expose the second surface 142C, which may be a carbon surface. And, rotation of the multi-surface module 110C to a third position will expose the third surface 144C, which may be a wood surface, for example. Thus, by rotating the body 120C a user can customize an outward appearance of the dashboard 12.

FIG. 4C illustrates an illuminated module 110D configured to be inserted into the channel 20 in accordance with the present disclosure. The illuminated module 110D includes a body 120D with any suitable text 150D printed thereon. The text 150D may be, for example, a model name/number of the vehicle, name of the manufacturer of the vehicle, name of the owner of the vehicle, etc. Within the body 120D is any suitable light source 152D, which is configured to illuminate the text 150D. At an exterior of the body 120D is any suitable electrical contact similar to, or identical to, the electrical contacts 122A. The electrical contacts 122A are configured to touch the electrical connectors 30 to transfer current to the illuminated module 110D to illuminate the light source 152D and the text 150D thereon.

FIG. 4D illustrates a display module 110E in accordance with the present disclosure. The display module 110E includes a base 120E and a display 160E supported by the base 120E. The base 120E is configured to be seated within the channel 20. The base 120E is rotatable within the channel 20 to vary a viewing angle of the display 160E. The display 160E is powered by electricity transferred to the display module 110E by way of the electrical connectors 30. The display 160E may be configured to receive data from the controller 70 to control the display 160E.

FIG. 4E illustrates a first personal electronic device (PED) support module 110F configured to be seated within the channel 20. The first PED support module 110F includes a base 120F, which is configured to be seated within the channel 20, such as slid into the channel 20 through either of the side openings 22. A first PED device 160F is mounted to the base 120F in any suitable manner, such as to allow the first PED device 160F to be mounted to, and decoupled from, the base 120F. The first PED device 160F may be a tablet computer, for example, or any other suitable electronic device. The first PED device 160F may be powered and/or charged by electrical current transferred to the first PED support module 110F by way of the electrical connectors 30 and electrical contacts on the base 120F (such as electrical contacts similar to the electrical contacts 122A). Data may be transferred to the first PED support module 110F from the controller 70 for display on the first PED device 160F.

FIG. 4F illustrates a second PED support module 110G configured to be seated within the channel 20. The second PED support module 110G includes a base 120G, which is configured to be seated within the channel 20, such as slid into the channel 20 through either of the side openings 22. A second PED device 170G is mounted to the base 120G in any suitable manner, such as to allow the second PED device 170G to be mounted to, and decoupled from, the base 120G. The second PED device 170G may be a smartphone, for example. FIG. 6A illustrates the second PED support module 110G including a holder 172G for supporting the second PED device 170G. A current transfer device 174G may be included to charge the second PED support device 170G. Current is transferred to the second PED support module 110G by contact between the electrical connectors 30 of the channel 20 and electrical contacts of the base 120G that are similar to the electrical contacts 122A. Current is ultimately transferred to the second PED device 170G by way of the current transfer device 174G, which may be any suitable wireless charging device or hard wire charging device.

FIG. 4G illustrates an active display module 110H in accordance with the present disclosure configured to be seated within the channel 20. The active display module 110H includes a base 120H and an active display 180H. The active display 180H may be operated, such as by the controller 70, to display any suitable text. The active display 180H may be powered by electrical current transferred to the active display module 110H by way of interaction between the electrical connectors 30 and electrical contacts of the active display module 110H similar to the contacts 122A.

FIG. 4H includes a gauge module 110I in accordance with the present disclosure. The gauge module 110I includes a base 120I configured to be seated within the channel 20. The gauge module 110I includes a plurality of gauges 1901, which are configured to display the status of various vehicle operations, conditions, parameters, etc. The gauge module 110I may be in wired or wireless communication with the controller 70, which is configured to control the gauges 1901 to display the status of the vehicle operations, conditions, parameters, etc. The gauge module 110I may be electrically connected to the electrical connector 30 to power the gauge module 110I.

FIG. 4I illustrates a flowerpot module 110J in accordance with the present disclosure. The flowerpot module 110J includes a base 120J, which is configured to be seated within the channel 20. The base 120J defines a receptacle 210J, which is configured to hold any suitable item, such as flowers 212J. The flowers 212J may be natural or artificial flowers. Any other suitable item may be placed in the receptacle 210J along with, or in place of, the flowers 212J.

FIG. 4J illustrates a fishtank module 110k in accordance with the present disclosure. The fishtank module 110k includes a base 120K, which is configured to be seated within the channel 20. The base 120K defines a receptacle 220K, which is configured to hold any suitable item, such as water and artificial fish 222K. The receptacle 220K is thus sealed in a water-tight manner to retain water and includes a transparent surface through which the fish 222K may be viewed. Any other suitable item may be placed in the receptacle 220K.

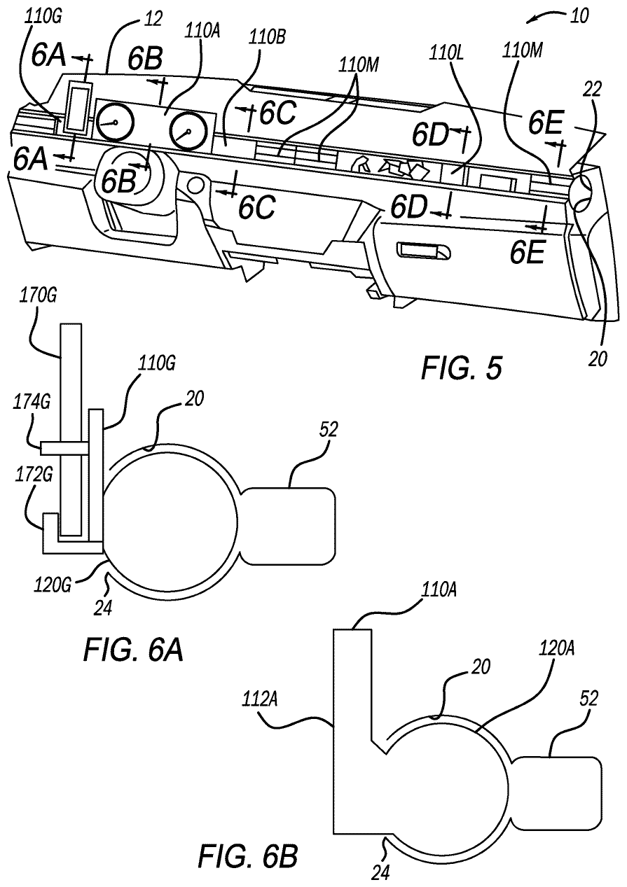

FIG. 5 illustrates the dashboard 12 including an exemplary arrangement of modules of the present disclosure arranged within the channel 20. Any suitable number of modules may be seated within the channel 20 in any suitable order. In the example of FIG. 5, the following modules are seated within the channel 20: the second PED module 110G; the instrument panel module 110A; the multi-colored module 110B; a plurality of the vent modules 110M; and the storage module 110L. More or less modules may be arranged in the channel 20 depending on the size of the modules. Also, the channel 20 need not be completely filled with modules. In the case were the channel 20 is not completely filled, any suitable spacers or “blanks” may be slid into cooperation with the channel 20 to fill the channel 20. The channel 20 may include any of the modules specifically described, as well as any other suitable modules.

FIGS. 6A and 6B are cross-sectional views of the second PED module 110G and the instrument panel module 110A respectively. In the examples illustrated, the base 120G and the base 120A are round, as is the channel 20. But in other configurations, the channel 20 may have a non-round cross-section, such as a square or rectangular cross-section. In such a configuration, the round bases 120G and 120A may be seated in a housing with an exterior square or rectangular shape that matches the shape of the channel 20. An interior of the housings will be round to match the shape of the round bases 120G and 120A, which will allow the bases 120G and 120A to rotate.

FIG. 6C illustrates the multi-colored module 110B, which is rotatable within the channel 20 to outwardly display any of the different colored surfaces 130B, 132B, and 134B. Both the body 120B and the channel 20 may be round as illustrated. Alternatively, the body 120B may be seated in a housing with an outer surface shaped to correspond to a non-round shape of the channel 20. An inner surface of the housing may be round to correspond to the shape of the body 120B. An end user may rotate the body 120B as desired to display any one of the first colored surface 130B, the second colored surface 132B, and the third colored surface 134B.

FIG. 6D illustrates the storage module 110L, which includes a container 250L that is rotatable. The container 250L defines an opening 252L. The container 250L is round to permit rotation within the channel 20, which in this example is also round. In other examples, the channel 20 may have any other suitable cross-sectional shape. In some applications, the rotatable container 250L may be seated within a housing having an exterior shape corresponding to a non-round shape of the channel 20. The container 250L is rotatable to expose the opening 252L at the front opening 24 of the channel 20, which allows access to an interior of the container 250L. The container 250L is further rotatable to move the opening 252L away from the front opening 24 to effectively close the container 250L. The container 250L is exposed to airflow from the HVAC system 50 flowing to the channel 20 by way of the ducts 52. The HVAC system 50 is configured to generate cold and/or warm airflow to chill or warm the item 260 within the container 250L. In the example illustrated, the airflow may be chilled airflow configured to maintain the item 260 at a relatively cool temperature. The item 260 may be any suitable food product, for example, such as an apple as illustrated.

The exemplary dashboard 12 of FIG. 5 includes a plurality of vent modules 110M. FIG. 6E illustrates one of the vent modules 110M in an open position to allow airflow from the duct 52 to flow out through the front opening 24 of the channel 20 to an interior of a cabin of a vehicle. The vent module 110M includes a case 270M with directionals 272M. The case 270M is rotatable within the channel 20 from the open position of FIG. 6E to the closed position of FIG. 6F. In the closed position of FIG. 6F, the case 270M and the directionals 272M are rotated from the position of FIG. 6E to block airflow of the duct 52 from flowing through the channel 20 and through the front opening 24 into the passenger cabin. In the example illustrated, the vent module 110M is round to match the channel 20. In applications where the channel 20 is not round, the round vent module 110M may be seated in a housing with a round interior and an exterior shaped to match the shape of the non-round channel 20.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between controllers, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

The controller may include one or more interface circuits. In some examples, the interface circuits may include wired or wireless interfaces that are connected to a local area network (LAN), the Internet, a wide area network (WAN), or combinations thereof. The functionality of any given controller of the present disclosure may be distributed among multiple controllers that are connected via interface circuits. For example, multiple controllers may allow load balancing. In a further example, a server (also known as remote, or cloud) controllers may accomplish some functionality on behalf of a client controller.

The term code, as used above, may include software, firmware, and/or microcode, and may refer to programs, routines, functions, classes, data structures, and/or objects. The term shared processor circuit encompasses a single processor circuit that executes some or all code from multiple controllers. The term group processor circuit encompasses a processor circuit that, in combination with additional processor circuits, executes some or all code from one or more controllers. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple controllers. The term group memory circuit encompasses a memory circuit that, in combination with additional memories, stores some or all code from one or more controllers.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A modular dashboard system comprising:
a dashboard defining a channel;
an electrical connector within the channel configured to be connected to a power source;
a plurality of modules each configured to be seated within the channel, at least some of the plurality of modules including electrical contacts configured to cooperate with the electrical connector of the channel to power the plurality of modules; and
a duct in fluid communication with both the channel and an HVAC system to transfer airflow conditioned by the HVAC system to the channel.

2. The modular dashboard system of claim 1, wherein the channel is configured to simultaneously receive at least two of the plurality of modules.

3. The modular dashboard system of claim 1, wherein the plurality of modules includes a vent module configured to be seated within the channel and movable between an open position and a closed position to control airflow.

4. The modular dashboard system of claim 1, wherein the plurality of modules includes an instrument panel module with a display configured to display data regarding operation of a vehicle.

5. The modular dashboard system of claim 1, wherein the plurality of modules includes a multi-colored module configured to rotate within the channel to outwardly display surfaces of different colors.

6. The modular dashboard system of claim 1, wherein the plurality of modules includes a multi-surface module configured to rotate within the channel to outwardly display surfaces of different appearances.

7. The modular dashboard system of claim 1, wherein the plurality of modules includes an illuminated module with a light source.

8. The modular dashboard system of claim 1, wherein the plurality of modules includes a display module with a display screen and a base configured to be seated within the channel.

9. The modular dashboard system of claim 1, wherein the plurality of modules includes a personal electronic device module with a base configured to be seated within the channel and a holder configured to support a personal electronic device.

10. The modular dashboard system of claim 9, wherein the personal electronic device module includes the electrical contacts configured to cooperate with the electrical connector of the channel, and includes a current transfer device configured to transfer electrical current to the personal electronic device to charge the personal electronic device.

11. The modular dashboard system of claim 1, wherein the plurality of modules includes an active display module including a display configured to display text.

12. The modular dashboard system of claim 1, wherein the plurality of modules includes a gauge module including a plurality of instrument gauges.

13. The modular dashboard system of claim 1, wherein the plurality of modules includes a flowerpot module defining a receptacle configured to receive a plurality of flowers.

14. The modular dashboard system of claim 1, wherein the plurality of modules includes a fishtank module with a plurality of artificial fish.

15. The modular dashboard system of claim 1, wherein the plurality of modules includes a storage module defining a housing configured to store an item therein.

16. The modular dashboard system of claim 15, wherein the storage module is in fluid communication with the duct to receive airflow from the HVAC system for at least one of heating and cooling a product stored within the housing.

17. A modular dashboard system comprising:
a dashboard defining a channel extending linearly along a width of the dashboard;
an electrical connector within the channel configured to be connected to a power source;
a plurality of modules each configured to be slid into the channel at one or more openings defined by the channel, at least some of the plurality of modules including electrical contacts configured to cooperate with the electrical connector of the channel to power the plurality of modules; and
a duct in fluid communication with both the channel and an HVAC system to transfer airflow conditioned by the HVAC system to the channel, a portion of the duct extending linearly along the channel.

18. The modular dashboard system of claim 17, wherein the plurality of modules includes at least one of a vent module, an instrument panel module, a multi-colored module, a multi-surface module, an illuminated module, a display module, a personal electronic device module, an active display module, a gauge module, a flowerpot module, a fishtank module, and a storage module.

19. A modular dashboard system comprising:
a dashboard defining a channel extending linearly along a width of the dashboard;
an electrical connector within the channel configured to be connected to a power source;
a plurality of modules each configured to be slid into the channel at one or more openings defined by the channel, at least some of the plurality of modules including electrical contacts configured to cooperate with the electrical connector of the channel to power the plurality of modules; and
a duct in fluid communication with both the channel and an HVAC system to transfer airflow conditioned by the HVAC system to the channel, a portion of the duct extending linearly along the channel;
wherein:
the channel is configured to simultaneously receive at least two of the plurality of modules; and
the plurality of modules includes a vent module configured to be seated within the channel and movable between an open position and a closed position to control airflow out from within the channel.

20. The modular dashboard system of claim 19, wherein the plurality of modules further includes at least one of an instrument panel module, a multi-colored module, a multi-surface module, an illuminated module, a display module, a personal electronic device module, an active display module, a gauge module, a flowerpot module, a fishtank module, and a storage module.
